(19) United States
(12) Patent Application Publication
(10) Pub. No.: US 2012/0278058 A1
(43) Pub. Date: Nov. 1, 2012

(54) PLC SIMULATOR BASED ON RECONFIGURABLE COMPONENTS

(75) Inventor: Sang Hun LEE, Gunpo-si (KR)

(73) Assignee: LSIS CO., LTD., Anyang-si (KR)

(21) Appl. No.: 13/440,725

(22) Filed: Apr. 5, 2012

(30) Foreign Application Priority Data
Apr. 27, 2011 (KR) 10-2011-0039664

(51) Int. Cl. G06F 9/44

(52) U.S. Cl. 703/21

(57) ABSTRACT

Provided is a PLC simulator including a component configuration unit receiving a command from a user to controllably perform a simulation, and a simulation unit receiving a command from the component configuration unit to perform a simulation of a connected external PLC, whereby a user is provided with a convenient environment capable of simulating a variety of systems through reconfigurable component, and a user is capable of reducing a TCO (Total Cost of Ownership) by being provided with a testing environment maximally similar to that of an actual apparatus through application of external input conditions.

### CROSS REFERENCE TO RELATED APPLICATIONS

Pursuant to 35 U.S.C. §119 (a), this application claims the benefit of earlier filing date and right of priority to Korean Patent Application No. 10-2011-0039664, filed on Apr. 27, 2011, the contents of which is hereby incorporated by reference in their entirety.

### BACKGROUND OF THE DISCLOSURE

1. Field of Endeavor

The present disclosure relates to a PLC simulator based on reconfigurable components, and more particularly to a PLC simulator based on reconfigurable components, configured to easily check program operations under various error situations.

2. Background

Simulation of PLC (Programmable Logic Controller) generally used in factory automation is conventionally realized after all the systems are actually installed in an actual site.

That is, in a conventional simulation method, an operator selects an apparatus making up the automatic assembly machine as the object of the simulation, and inputs a simulation program for the selected apparatus. In this case, a program dedicated for the simulation (i.e., a program for virtually operating the automatic assembly machine) that is different from the ladder program for the actual automatic assembly machine has to be input. Therefore, time and resources are needed to prepare and input such a program, and in turn, the efficiency of debugging through simulation may be degraded.

However, in the PLC-based factory automation processes, systems or apparatus may be damaged in the course of simulation, and it costs a lot to simulate the processes, such that attempts are made to simulate the PLC itself.

Configuration of conventional PLC simulator is described with reference to FIG. 1.

First, the conventional PLC simulator stores a user program received from a program preparation unit 10 in a common memory 20 of a PLC. The program stored in the PLC common memory 20 and data are calculated using a PLC logic processor 30 and a PLC desk processor 40, and a result thereof is stored again in the PLC common memory 20. At this time, data value in the PLC common memory 20 may be directly changed by a data input unit 50 in order to test the user program. An output display unit 60 may display the data inside the PLC common memory 20 using a graphic interface (e.g., a lamp). However, the conventional PLC simulation thus described has the following disadvantages.

First, sizes of data memory inside the PLC and a programmable user program are different depending on types of PLC. It is difficult to simulate a user program prepared on the types, and as a result, a user must change the user program to a type catering to the simulator, or simulation must be performed through internal changes to make it impossible to simulate the user program as it is.

Second, analogue input data must be prepared, not an actual analogue value, but in a discrete value. The discrete value changed from the analogue value applied from outside of PLC is also a part of the user program, such that an error that might be generated in an actual PLC system cannot be tested if the data is inputted in the discrete value instead of the analogue value.

Third, no support to communication components is possible. Recently, PLC application technology has expanded from a simple system of input/output control to a system control field connected to serial and Ethernet-based network. Thus, an interaction portion must be simulated through a communication component instead of a simple data value change or data display, in order to simulate the system-based control system.

### SUMMARY

The present disclosure has been made to solve the foregoing problems of the prior art, and therefore an object of certain embodiments of the present invention is to provide a PLC simulator configured to form reconfigurable components whereby a user can be provided with a convenient environment capable of simulating a variety of systems.

Another object is to provide a PLC simulator configured to easily check program operations of various errors that cannot be verified if not by actual facilities in a PLC application technology field, and program operations of various errors that are difficult to be generated if not by the actual facilities.

Still another object is to provide a PLC simulator configured to allow a user to reduce a TCO (Total Cost of Ownership) by providing a testing environment maximally similar to that of an actual apparatus through application of external input conditions.

In one general aspect of the present disclosure, there is provided a PLC simulator, the PLC simulator comprising: a component configuration unit receiving a command from a user to controllably perform a simulation; and a simulation unit receiving a command from the component configuration unit to perform a simulation of a connected external PLC.

Preferably, but not necessarily, the component configuration unit includes an input unit receiving a command from the user, a controller processing the command inputted from the input unit, a selection unit selecting a component, first storage storing a user PLC program and data under calculation, and second storage storing a component set up by the user.

Preferably, but not necessarily, the simulation unit includes a program preparation unit preparing a PLC program, a communication component receiving and transmitting the prepared program and data, a memory component storing the prepared user program and the data under calculation, and an input/output component inputting and outputting the data stored in the memory component.

Preferably, but not necessarily, the simulation unit includes an input module component connected to the input/output component to simulate an external PLC input module, and an output module component connected to the input/output component to simulate an external PLC output module.

Preferably, but not necessarily, the simulation unit includes a data converter for data conversion, a special module component for simulation of a special module, and a communication module component for serial communication or TCP/IP communication with an outside.

Preferably, but not necessarily, the PLC simulator further comprises a channel manager for interface with an external input device and an external output device.

Preferably, but not necessarily, the component configuration unit reconfigures the simulation unit based on a user input.

The PLC simulator according to the present disclosure has an advantageous effect in that a user is provided with a convenient environment capable of simulating a variety of systems through reconfigurable component, it is easy to check program operations of various errors that cannot be verified if not by actual facilities in a PLC application technology field, and program operations of various errors that are difficult to be generated if not by the actual facilities, and a user is capable of reducing a TCO (Total Cost of Ownership) by being provided with a testing environment maximally similar to that of an actual apparatus through application of external input conditions.

### BRIEF DESCRIPTION OF THE DRAWINGS

The drawing figures depict one or more exemplary embodiments in accord with the present concepts, by way of example only, not by way of limitations. In the figures, like reference numerals refer to the same or similar elements.

Thus, a wide variety of potential practical and useful embodiments will be more readily understood through the following detailed description of certain exemplary embodiments, with reference to the accompanying exemplary drawings in which:

FIG. 1 is a schematic block diagram explaining problems encountered by prior art;

FIG. 2 is a schematic diagram illustrating an operation of a PLC simulator according to an exemplary embodiment of the present disclosure;

FIG. 3 is a schematic block diagram illustrating a configuration of a component configuration unit, which is a configuration of a PLC simulator, according to an exemplary embodiment of the present disclosure; and

FIG. 4 is a schematic block diagram illustrating a configuration of a simulation unit, which is a configuration of a PLC simulator, according to an exemplary embodiment of the present disclosure.

### DETAILED DESCRIPTION

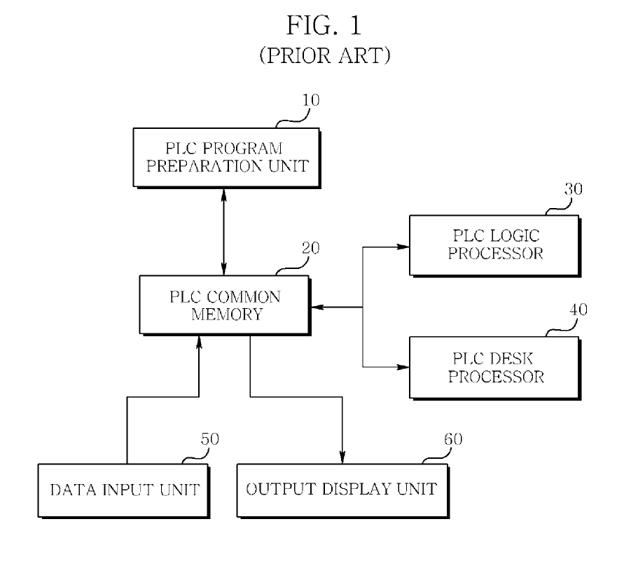

The disclosed embodiments and advantages thereof are best understood by referring to FIGS. 1-4 of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments, and protected by the accompanying drawings. Further, the illustrated figures are only exemplary and not intended to assert or imply any limitation with regard to the environment, architecture, or process in which different embodiments may be implemented. Accordingly, the described aspect is intended to embrace all such alterations, modifications, and variations that fall within the scope and novel idea of the present invention.

Meanwhile, the terminology used herein is for the purpose of describing particular implementations only and is not intended to be limiting of the present disclosure. The terms “first,” “second,” and the like, herein do not denote any order, quantity, or importance, but rather are used to distinguish one element from another. For example, a second constituent element may be denoted as a first constituent element without departing from the scope and spirit of the present disclosure, and similarly, a first constituent element may be denoted as a second constituent element.

As used herein, the terms “a” and “an” herein do not denote a limitation of quantity, but rather denote the presence of at least one of the referenced item. That is, as used herein, the singular forms “a”, “an” and “the” are intended to include the plural forms as well, unless the context clearly indicates otherwise.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Also, “exemplary” is merely meant to mean an example, rather than the best. If is also to be appreciated that features, layers and/or elements depicted herein are illustrated with particular dimensions and/or orientations relative to one another for purposes of simplicity and ease of understanding, and that the actual dimensions and/or orientations may differ substantially from that illustrated.

That is, in the drawings, the size and relative sizes of layers, regions and/or other elements may be exaggerated or reduced for clarity. Like numbers refer to like elements throughout and explanations that duplicate one another will be omitted. As may be used herein, the terms “substantially” and “approximately” provide an industry-accepted tolerance for its corresponding term and/or relativity between items.

Hereinafter, the present disclosure will be described in detail with reference to the accompanying drawings.

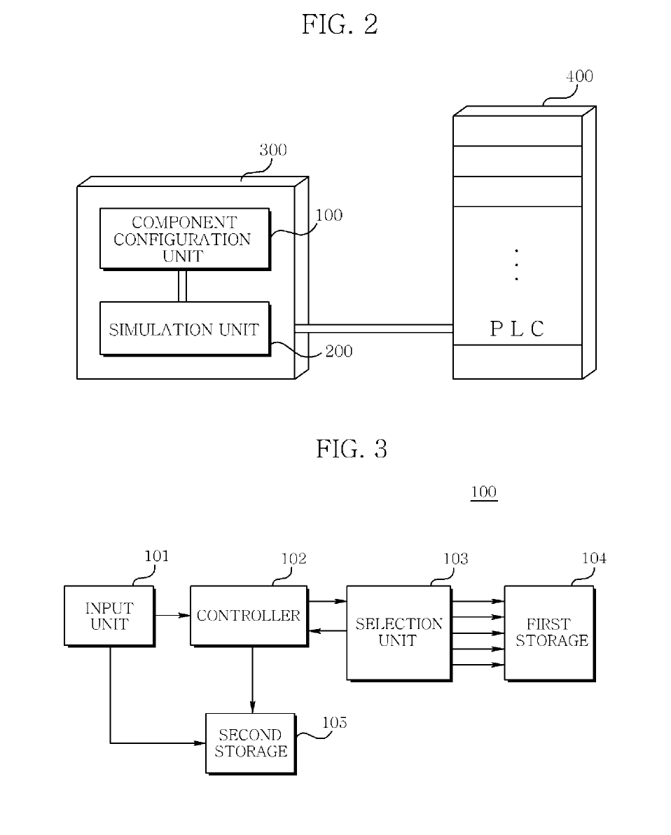

FIG. 2 is a schematic diagram illustrating an operation of a PLC simulator according to an exemplary embodiment of the present disclosure.

Referring to FIG. 2, a PLC simulator 300 is connected to a PLC apparatus 400 to perform a simulation. In case of the PLC simulator according to the exemplary embodiment of the present disclosure, a PLC program can be verified free from a PLC, such that there is no need of connecting the PLC apparatus 400 as shown in FIG. 2. However, the PLC simulator 300 that is connected to the PLC apparatus 400 is proposed for explanation in the present disclosure as a way of assisting in understanding the present disclosure easily.

The PLC simulator 300 includes a component configuration unit 100 and a simulation unit 200. The simulation of the PLC apparatus 400 can be performed by interaction between the component configuration unit 100 and the simulation unit 200. Meanwhile, the component configuration unit 100 may re-configure the simulation unit 200 according to a user setting.

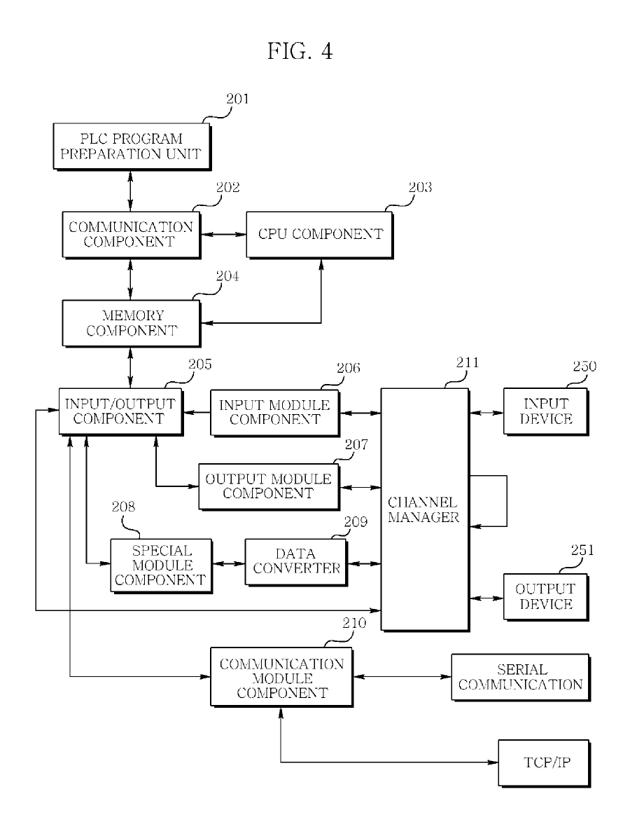

The component configuration unit 100 includes an input unit, a controller, a selection unit and first and second storages. These configurations function to re-configure the configuration of the simulation unit 200 by receiving a user command from a user, or to controllably allow the simulation unit 200 to perform simulation of the PLC apparatus 400. Each function performed by each configuration will be described in detail with reference to FIG. 3.

Meanwhile, the simulation unit 200 includes a PLC program preparation unit, a communication component, a CPU component, a memory component, and an input/output component. As a configuration for performing the PLC simulation by being connected to the PLC apparatus 400, the simulation unit 200 also includes an input/output module component, a special module component, a data converter, a channel manager and a communication module component. Although functions of these components will be described in detail with reference to FIG. 4, these components largely perform data reception/transmission and process with the PLC apparatus 400 in performing the simulation with the PLC apparatus 400.

Based on the configuration of the PLC simulator 300 according to the exemplary embodiment of the present disclosure illustrated in FIG. 2, a convenient environment can be provided capable of allowing a user to simulate a variety of systems through re-configurable components. Furthermore, it is easy to check program operations of various errors that cannot be verified if not by actual facilities in a PLC application technology field, and program operations of various errors that are difficult to be generated if not by the actual facilities. Still furthermore, a user is capable of reducing a TCO (Total Cost of Ownership) by being provided with a testing environment maximally similar to that of an actual apparatus through application of external input conditions.

Hereinafter, configuration forming the PLC simulator 300 according to an exemplary embodiment of the present disclosure and functions thereto will be described in detail with reference to the accompanying drawings.

FIG. 3 is a schematic block diagram illustrating a configuration of a component configuration unit 100, which is a configuration of a PLC simulator, according to an exemplary embodiment of the present disclosure.

Referring to FIG. 3, the component configuration unit 100 includes an input unit 101, a controller 102, a selection unit 103 and first and second storages 104, 105.

The input unit 101 functions to receive a user input. To be more specific, the input unit 101 functions to receive a component performing a simulation selected by a user, or receive from a user a command for controlling the PLC simulator 300. In addition, in a case a user wishes to change a detailed attribute of each component, the input unit 101 functions to receive from the user a command for changing the detailed attribute of each component inside the second storage 105 storing a component to be described later.

The controller 102 functions to control an overall operation of the PLC simulator 300. To be more specific, the controller 102 functions to perform a PLC simulation based on the command inputted from the user through the input unit 101. The selection unit 103 functions to select components. To be more specific, the selection unit 103 functions to a component necessary for performing the PLC simulation based on the user selection inputted from the input unit 101. To be further specific, the selection unit 103 may select a component stored in the first storage 104 storing component data.

The first storage 104 functions to store types and attributes of a variety of components that are used for PLC simulation. That is, the first storage 104 may be called a component data base.

The second storage 105 functions to store a component set up by the user. That is, the second storage 105 can change the attribute of the component stored in response to the user command inputted from the input unit 101, and the attribute-changed set-up component may be stored in the second storage 105.

To sum up, the component configuration unit 100 included in the PLC simulator 300 receives a command from the user through the input unit 101 to change a detailed attribute of each component inside the first storage 104 that is a component data base, and stores the attribute-changed component in the second storage 105 and uses the attribute-changed component in the PLC simulation.

Through these configurations, the user can perform the PLC simulation more conveniently using the reconfigurable component-based PLC simulator. That is, the simulator is re-configured in response to the user setting, whereby the actual programs used in actual facilities can be tested under an environment that is same as that of the actual equipment.

FIG. 4 is a schematic block diagram illustrating a configuration of a simulation unit 200, which is a configuration of the PLC simulator 300, according to an exemplary embodiment of the present disclosure.

Referring to FIG. 4, the simulation unit 200 includes a program preparation unit 201, a communication component 202, a CPU component 203, a memory component 204 and an input/output component 205. In addition, the simulation unit 200 includes an input module component 206 for data reception/transmission with the PLC apparatus 400, an output module component 207, a special module component 208, a data converter 209, a communication module component 210 and a channel manager 211.

The program preparation unit 201 functions to prepare a PLC program. That is, the user can use the component configuration unit 100 to simulate the prepared PLC program. Once the PLC program is prepared, the simulation is executed according to a sequence of the program to perform the PLC simulation.

The communication component 202 functions to transmit the program information prepared by the program preparation unit 201 to the memory component 204. The memory component 204 functions to store the program information prepared by the program preparation unit 201, where the stored program information is used as reference in performing the simulation by the CPU component 203.

The CPU component 203 functions to perform the simulation according to sequence based on the program information stored in the memory component 204. The data necessary for execution and a result of the execution is read out from or stored in the memory component 204.

The input/output component 205 serves to periodically transmit the data of the memory component 204 to a plurality of module components, or read out from the plurality of module components and store the data in the memory component 204.

The input module component 206 is a configuration for simulating an input module of the PLC apparatus 400, and functions to transmit the data transmitted by the input/output component 205 to an external output device 251. Furthermore, the output module component 207 is a configuration for simulating an output module of the PLC apparatus 400, and transmits the data received from an external input device 250 to the input/output component 205. At this time, the data received and transmitted between the input module component 206 and the external output device 251, and the data received and transmitted between the output module component 207 and the external input device 250 are realized through the channel manager 211.

The special module component 208 and the data converter 209 are connected to the input/output component 205 to simulate a special module inside the PLC apparatus 400. The special module component 208 functions to transmit the data converted by the data converter 209. To be more specific, an analogue-related component in the special module component is transmitted to the channel manager 211 through the data converter 209. Furthermore, the analogue data inputted from the channel manager 211 is converted to a digital data through the data converter 209, where the converted digital data is transmitted to the input/output component 205.

The data converter 209 functions to convert an analogue data to a digital data, or convert a digital data to an analogue data. In a case a data inputted from the PLC apparatus 400 is of an analogue value, effect of performing the simulation can be brought forth by the data converter 209.

The communication module component 210 has a communication function for data transmission. To be more specific, the communication module component 210 uses a serial communication and TCP/IP protocol to transmit and receive data using a variety of communication methods.

The PLC simulator 300 according to exemplary embodiments of the present disclosure thus configured can effectively simulate the data input/output processes through a communication interface.

Meanwhile, the channel manager 211 functions to perform an interface between the external input device 250 and the external output device 251.

As apparent from the foregoing component configuration unit 100 and the simulation unit 200, the PLC simulator 300 according to the exemplary embodiments of the present disclosure can re-configure the components, whereby a user can be provided with a convenient environment capable of simulating a variety of systems.

Furthermore, the PLC simulator is provided configured to easily check program operations of various errors that cannot be verified if not by actual facilities in a PLC application technology field, and program operations of various errors that are difficult to be generated if not by the actual facilities.

Still furthermore, a user is capable of reducing a TCO (Total Cost of Ownership) by being provided with a testing environment maximally similar to that of an actual apparatus through application of external input conditions.

Still furthermore, the data input/output processes can be effectively simulated through a communication interface, and the simulation can be effectively performed regardless of whether data applied from the PLC apparatus is an analogue data or a digital data.

Although the present disclosure has been described with reference to a number of illustrative embodiments thereof, it should be understood that numerous other modifications and embodiments can be devised by those skilled in the art that will fall within the spirit and scope of the principles of this disclosure.

More particularly, various variations and modifications are possible in the component parts and/or arrangements of subject combination arrangement within the scope of the disclosure, the drawings and the appended claims. In addition to variations and modifications in the component parts and/or arrangements, alternative uses will also be apparent to those skilled in the art.

What is claimed is:

1. A PLC (Programmable Logic Controller) simulator, the PLC simulator comprising: a component configuration unit receiving a command from a user to controllably perform a simulation; and a simulation unit receiving a command from the component configuration unit to perform a simulation of a connected external PLC.

2. The PLC simulator of claim 1, wherein the component configuration unit includes an input unit receiving a command from the user, a controller processing the command inputted from the input unit, a selection unit selecting a component, first storage storing a user PLC program and data under calculation, and second storage storing a component set up by the user.

3. The PLC simulator of claim 1, wherein the simulation unit includes a program preparation unit preparing a PLC program, a communication component receiving and transmitting the prepared program and data, a memory component storing the prepared program and the data under calculation, and an input/output component inputting and outputting the data stored in the memory component.

4. The PLC simulator of claim 3, wherein the simulation unit includes an input module component connected to the input/output component to simulate an external PLC input module, and an output module component connected to the input/output component to simulate an external PLC output module.

5. The PLC simulator of claim 3, wherein the simulation unit includes a data converter for data conversion, a special module component for simulation of a special module, and a communication module component for serial communication or TCP/IP communication.

6. The PLC simulator of claim 1, further comprising a channel manager for interface with an external input device and an external output device.

7. The PLC simulator of claim 1, wherein the component configuration unit reconfigures the simulation unit based on a user input.
